(19) United States
(12) Patent Application Publication
(10) Pub. No.: US 2011/0004501 A1
(43) Pub. Date: Jan. 6, 2011

(54) Methods and Apparatus for Automatically Generating Social Events

(76) Inventors: Shekhar S. Pradhan, Poughkeepsie, NY (US); Bryan C. Welfel, River Vale, NJ (US)

Correspondence Address: LAW OFFICES OF MICHAEL L. WISE, LLC, 260 WALSH RD., LAGRANGEVILLE, NY, 12540, US

(21) Appl. No.: 12/496,666

(22) Filed: Jul. 2, 2009

(51) Int. Cl. G06Q 99/00; G01C 21/00; G06Q 10/00; G06F 15/16; G06F 3/048; G06N 7/02

(52) U.S. Cl. 705/8; 701/207; 705/10; 709/206; 715/757; 706/52; 705/319

(57) ABSTRACT

A social event is generated by a computer having a data processor in signal communication with a memory. Initially, each user of a plurality of users is associated with a respective user location, a respective user time window, and at least one respective user interest. The computer then determines a common interest group, the common interest group comprising a subgroup of the plurality of users having user locations that collectively exceed a predetermined geographic density, overlapping user time windows, and a common user interest. After determining the common interest group, the computer proceeds to determine a venue and a meeting time for the social event. The computer then transmits the venue and meeting time to at least a portion of the users within the common interest group.

### FIELD OF THE INVENTION

The present invention relates generally to the automated generation of social events, and, more particularly, to computer-implemented methods and computer apparatus for automatically generating social events.

### BACKGROUND OF THE INVENTION

Human beings often find it desirable to meet socially with others having similar interests in the real world or virtual worlds. In the past, in the real world, newsletters and bulletin boards were used to notify people of such upcoming social events. However, more recently, with the proliferation of the Internet (i.e., World Wide Web), several web-based systems have been developed that act to facilitate these social gatherings. The web-based system Meetup® provided by Meetup Inc (New York, N.Y., USA) (www.meetup.com), for example, allows users to join various regional groups that are directed at differing interests. A regional group may, as just one example, include members living in New England who are interested in reading and discussing books. Once so joined, a user is electronically informed of social events that are scheduled by other members of that user's chosen group or groups. An event might, for instance, comprise meeting at a coffee shop on a specific date and time.

Nevertheless, these existing web-based systems suffer from several disadvantages. For example, they typically require that a user find and join a group before that user is invited to participate in the social events of that group. A user must, therefore, first actively seek out one or more groups related to that user's particular user interests and then act to become a member of those groups. Where a user has many interests, this can become burdensome. In addition, as indicated above, the groups in the existing web-based solutions are typically regionalized, meaning that they only serve a particular geographic region. The regionalized nature of these groups is rationalized on the presumption that it would make little sense to invite a person living in California to a social event occurring in New York. Nevertheless, no account is taken of the possibility that the person living in California may be traveling to New York and at least temporarily available to participate. Finally, existing web-based systems typically rely on the members of the groups to arrange the various social events. As a result, the scope and frequency of social events largely depends on the level of motivation of the membership. Where a less engaged membership is present, social events may be few and far between.

In a virtual world (i.e., a world simulated by a computer), some analogous disadvantages are present. Current systems require players to actively seek grouping with others and take initiative to create social events which are represented as quests. Gaming systems of the virtual world currently allow groups to access a set of quests but this misses the possibility of dynamically creating events in the form of quests for gathering of players with certain kinds of skills, geographical proximity, and interests.

Both in the real world and the virtual world events that could have been brought into existence remain uncreated because of a lack of initiative or awareness of the availability of components at hand for successfully creating this event. As a result, there is a need for improved social event planning methods and apparatus that address the above-identified deficiencies by helping to create events that could have happened but didn't because of lack of initiative or awareness.

### SUMMARY OF THE INVENTION

Embodiments of the present invention provide methods and apparatus for automatically generating social events that address the above-identified needs.

In accordance with an aspect of the invention, a social event is generated by a computer having a data processor in signal communication with a memory. Initially, each user of a plurality of users is associated with a respective user location, a respective user time window, and at least one respective user interest. The computer then determines a common interest group, the common interest group comprising a subgroup of the plurality of users having user locations that collectively exceed a predetermined geographic density, overlapping user time windows, and a common user interest. After determining the common interest group, the computer proceeds to determine a venue and a meeting time for the social event. The computer then transmits the venue and meeting time to at least a portion of the users within the common interest group.

In accordance with one of the above-identified embodiments of the invention, an apparatus for generating social events comprises a data processor, web server, and memory. Initially, the apparatus receives and stores user interest information for a plurality of users as part of a user registration process. Then, as a part of an automatic social event generation process, the apparatus receives user location and user time window data from the users. The user location data indicates where the users wish to participate in social events, while the user time window data indicates when the users wish to participate. From this data, the apparatus determines whether there are any common interest groups, a common interest group comprising a subgroup of users having user locations that collectively exceed a predetermined geographic density, overlapping user time windows, and a common user interest. For each determined common interest group, the apparatus proposes a venue and meeting time for a social event and polls the members of the common interest group for their attendance. In the real world, if attendance is deemed sufficient, the apparatus electronically informs the venue that there will be a social event and electronically informs the attending users of the final venue and meeting time. In the virtual world, if attendance is deemed sufficient, the quest would be generated and electronically inform the attending users of the final venue and meeting time.

Advantageously, the above-described embodiments address several of the disadvantages and weaknesses found in other social planning systems. Embodiments of the invention, for example, generate social events based on happenstance geographic clustering of users rather than based on memberships in regionalized groups. A user is therefore not required to pre-join one or more groups in order to be invited to social events that may be of interest to that user. In addition, a user who is travelling is availed of the possibility of social events no matter where that user happens to be presently located. Lastly, embodiments of the invention also automatically propose, plan, and communicate the details of social events without requiring that the members of a group perform those tasks. As a result, social events can take place more often because less dependence is placed on the level of motivation and engagement of the various members.

### BRIEF DESCRIPTION OF THE DRAWINGS

These and other features, aspects, and advantages of the present invention will become better understood with regard to the following description, appended claims, and accompanying drawings where:

FIG. 1 shows a social event generation apparatus in accordance with an illustrative embodiment of the invention, as well as various external elements;

FIG. 2 shows a flow diagram of an illustrative user registration method for use with the FIG. 1 apparatus;

FIG. 3 shows an illustrative webpage that might be generated by the FIG. 1 apparatus as part of the FIG. 2 user registration method;

FIG. 4 shows a flow diagram of an illustrative social event generation method for use with the FIG. 1 apparatus;

FIG. 5 shows a first illustrative mobile computing device message that might be generated by the FIG. 1 apparatus as part of the FIG. 4 social event generation method;

FIG. 6 shows a second illustrative mobile computing device message that might be generated by the FIG. 1 apparatus as part of the FIG. 4 social event generation method; and

FIG. 7 shows a third illustrative mobile computing device message that might be generated by the FIG. 1 apparatus as part of the FIG. 4 social event generation method.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

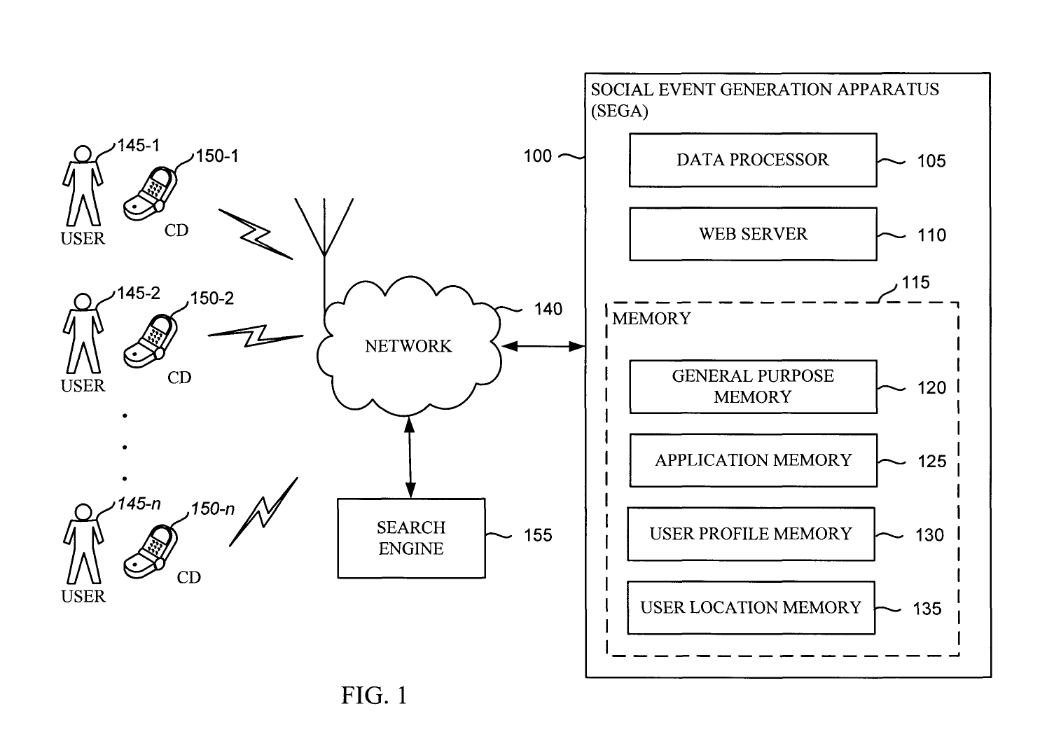

FIG. 1 shows a social event generation apparatus (SEGA) 100 in accordance with an illustrative embodiment of the invention, as well as various external elements. The SEGA comprises a data processor 105, a web server 110, and a memory 115. The memory, in turn, comprises a general purpose memory 120, an application memory 125, a user profile memory 130, and a user location memory 135. The SEGA is communicatively coupled to a network 140, which communicates with a plurality of users 145-1 to 145-n (collectively “the users 145”) via the users' respective communication devices 150-1 to 150-n (collectively “the communication devices 150”) (labeled as “CDs” in the figure). In addition, the network further allows the SEGA to communicate with a search engine 155.

The communication devices 150 may comprise any combination of static or mobile devices configured for wired or wireless data communication, such as, but not limited to, personal computers, laptop computers, mobile phones, personal digital assistants, and so on. Each communication device includes a browser (or other similar application) that allows the associated user 145 to interface and communicate with the SEGA 100 over the network 140. One example browser is the OpenWave® browser provided by OpenWave Systems Inc. (Redwood City, Calif., USA) (a common browser on cellular telephones). Other example browsers include Internet Explorer® provided by Microsoft Corp. (Redmond, Wash., USA), Netscape Navigator® provided by Netscape Communications Corp. (Mountain View, Calif., USA), Firefox® provided by Mozilla Foundation (Mountain View, Calif., USA), Safari® provided by Apple Inc. (Cupertino, Calif., USA), or any other browsing or application software capable of communicating with the network. In addition to a browser, the communication devices may further comprise the messaging software required to send and receive electronic mail messages (hereinafter “email messages”), messages in accordance with the Short Message Service (SMS) format (hereinafter “SMS messages”), messages in accordance with the Multimedia Message Service (MMS) format (hereinafter “MMS messages”), and messaging systems embedded within gaming services such as Internet Relay Chat (IRC) (hereinafter “IRC messages”). Finally, if mobile technology in the real world is being utilized, the communication devices may comprise GPS hardware capable of determining the location of the device. Many modern mobile phones, for example, include the browser, messaging, and GPS capabilities described above.

The data processor 105 of the SEGA 100 is operative to execute instructions stored in the application memory 125. The web server 110, in contrast, is the portion of the SEGA that delivers Hypertext Markup Language (HTML) webpage data, images, scripting language (e.g., JavaScript, JScript, Visual Basic Script), email messages, SMS messages, MMS messages, IRC messages, and other elements that may used by the browser and messaging software on the communication devices 150. Note that the web server may include one or more servers operating under a load balancing scheme, with each web server (or a combination of web servers) configured to respond to and interact with the communication devices. The data processor and web servers can be implemented with conventional or custom technology, as will be apparent to one skilled in the art. As just one example, they may comprise AS/400®, iSeries®, or i5® servers available from International Business Machines Corporation (Armonk, N.Y., USA), or any one of many analogous computers.

The memory 115 (and its various subparts 120, 125, 130, 135) may comprise any combination of hardware capable of storing digital data. The memory may for example comprise some combination of volatile memory (e.g., static random access memory (SRAM) and dynamic random access memory (DRAM)), and non-volatile memory (e.g., hard disks, floppy disks, magnetic tapes, and optical disks).

The network 140 may be any type of data network, such as a wide area network (e.g., the Internet), local area network, cellular telephone network, satellite network, or some combination thereof. The network can communicate with the SEGA 100, the communication devices 150, and the search engine 155 through wires, wirelessly, or with some mixture of these communication infrastructures. In general, the network can be implemented with any number of conventional or custom technologies, and can employ numerous communication protocols and transmission techniques (e.g., Time Division Multiple Access (TDMA), Code Division Multiple Access (CDMA), Transmission Control Protocol/Internet Protocol (TCP/IP), and inter-network interfaces (e.g., cellular-to-Internet network interface)) as needed to allow for the desired communications between the elements shown in FIG. 1.

Finally, the search engine 155 may comprise any search engine capable of providing venue information (e.g. for the real world: name, address, phone number, and user reviews; e.g. for the virtual world: name of a quest, difficulty level, and rewards) for a particular geographic region. As used herein, the term “venue” includes any place, scene, or setting where a social event might occur (e.g., real or virtual bar, restaurant, park, and sports stadium) or where the social event begins, in case the activity associated with the event requires moving from one location to another. Several such search engines are presently publicly available including Google Maps provided by Google Inc. (Mountain View, Calif., USA), Local Maps provided by Yahoo! Inc. (Sunnyvale, Calif., USA), and Bing provided by Microsoft Corp. (Redmond, Wash., USA), or other external or internal search engines.

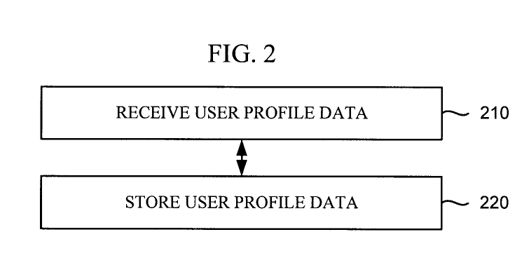

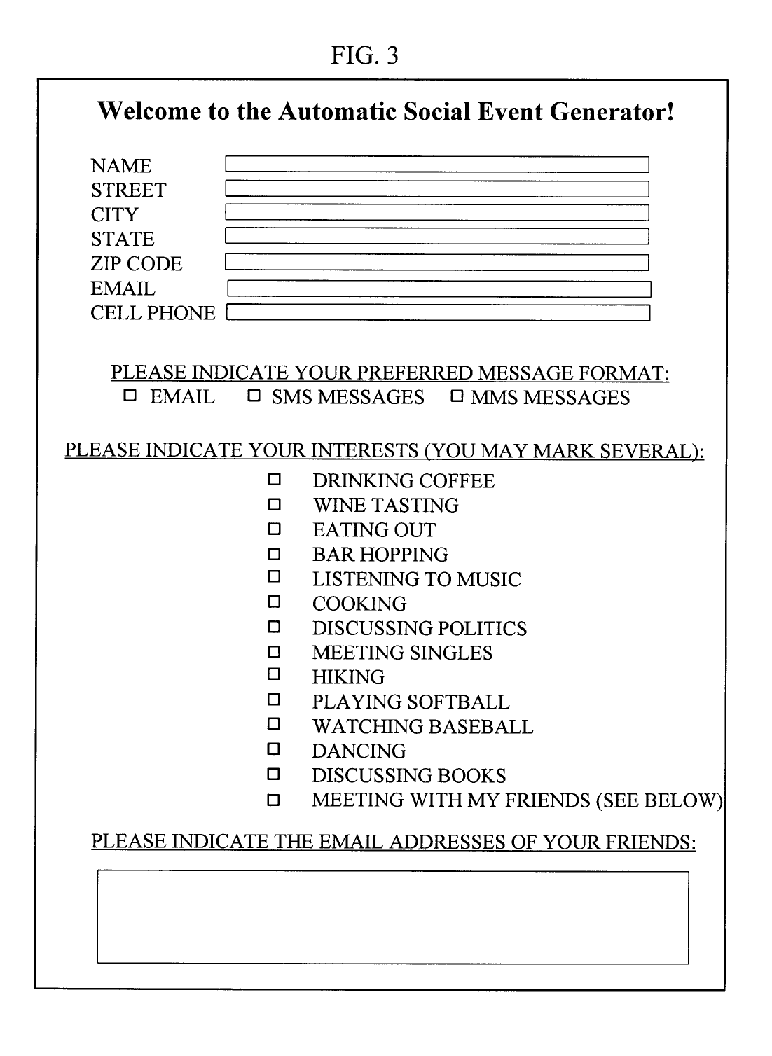

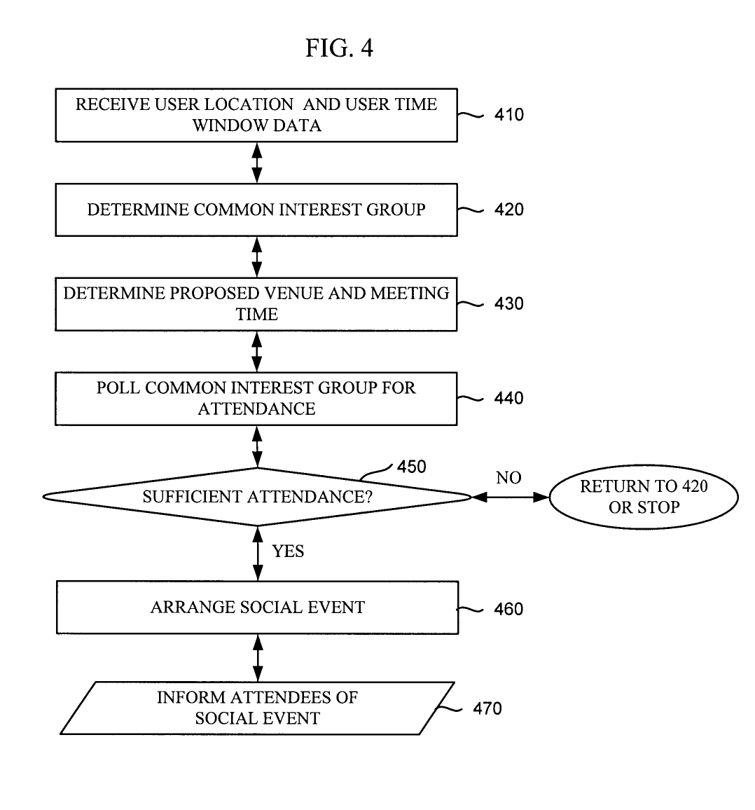

An illustrative method for utilizing the SEGA 100 to automatically generate social events may now be described. As used herein, the term “social event” is intended to incorporate a gathering of people at a location in physical space or virtual space for the purpose of engaging in a group activity. The term is meant to be interpreted broadly; a social event may be something as specific as eating a meal, something as general as conversing, or engaging in a quest. For clarity and ease of understanding, the illustrative method may be separated into two portions. FIGS. 2 and 3 describe the “user registration” portion of the illustrative method. FIGS. 4-7 describe the “automatic social event generation” portion.

More specifically, FIG. 2 provides a flow chart that shows aspects of the registration portion of the illustrative method. The user registration begins with step 210, wherein the SEGA 100 provides a new user 145 with a webpage that queries that user for user profile information. FIG. 3 shows an exemplary webpage that might be presented to a new user in this step. In the webpage, the user is asked to input various pieces of information such as the user's name, postal address, email address, and cellular telephone number. In addition, the new user is asked to select in which format the user prefers to receive notifications from the SEGA (i.e., email messages, SMS messages, or MMS messages). Lastly, the new user is asked to select from several choices indicative of that user's interests. In this particular example, choices range from “drinking coffee” to “meeting with my friends.” Nevertheless, this limited number of choices is merely meant to illustrate the concept of providing a user with a selection of user interests. In actual practice, it is contemplated that a new user would be given a substantially broader number of choices and choices may be very different depending on the nature of social events, especially given the variety that can occur between the real and virtual worlds.

It will be noted that, with respect to the user interest of “meeting with my friends,” the exemplary webpage provides an additional input field allowing the new user 145 to provide the email addresses of those friends. This extra field allows the SEGA 100 to recognize the members of that particular user's group of friends and to schedule social events comprising meeting with that group. These friend-based social events are generated in a manner similar to that for other user interests (as further detailed below).

In addition to, or as an alternative to, having a new user 145 provide that user's user interests during registration in step 210, the SEGA 100 may also search internal or external sources for such information. For example, many users of the Internet make their various interests public on social websites such as Facebook® provided by Facebook, Inc. (Palo Alto, Calif., USA) and MySpace® provided by MySpace, Inc. (Beverly Hill, Calif., USA). Accordingly, the SEGA may search these various sources in order to obtain user interest information for a user's profile. A new user is thereby required to manually provide less information to the SEGA in step 210.

Once a user 145 has provided the user's registration information (or allowed it to be gathered from other sources), the new user's profile is saved in the user profile memory 130 in step 220.

FIG. 4 goes on to present a flow diagram showing aspects of the automatic social event generation portion of the illustrative method. Although described separately from the user registration portion in FIG. 2, both portions of the illustrative method may be performed simultaneously by the SEGA 100.

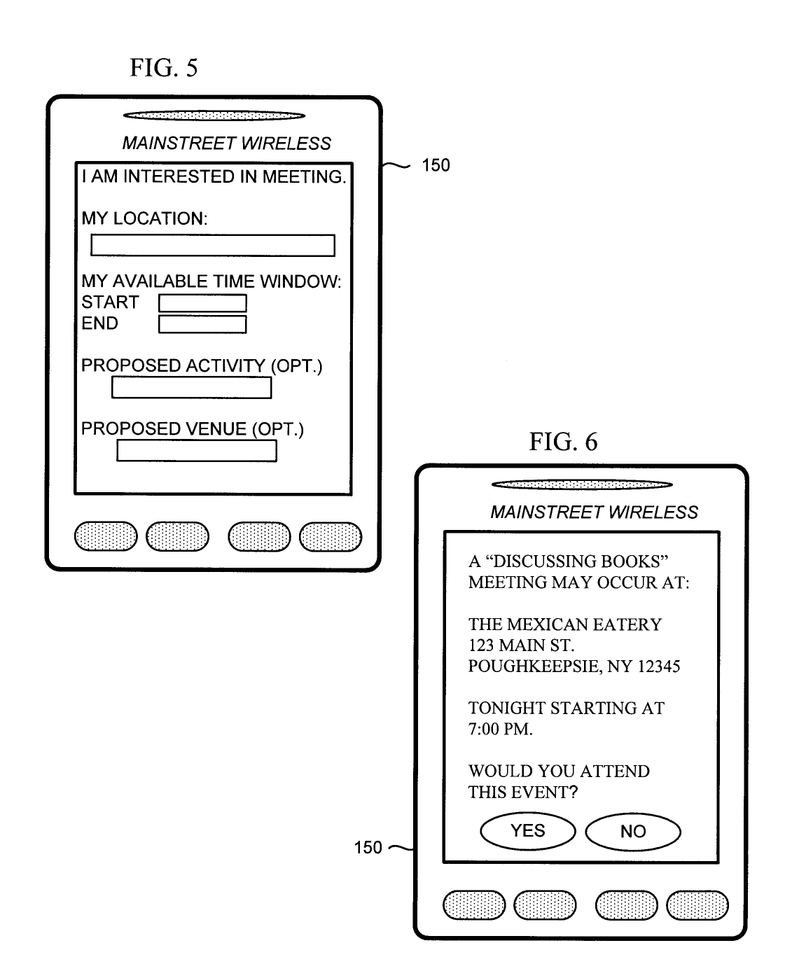

In step 410, the SEGA 100 receives “user location” and “user time window” data from those users 145 interested in participating in a social event. A user's “user location” indicates where that user desires to participate in a social event, while a user's “user time window” indicates when that user desires to participate. In the present illustrative embodiment, this data is collected by having users “check-in” on a purpose-specific webpage provided by the web server 110. An illustrative example of such a webpage is shown in FIG. 5. By entering a location into the “my desired location” field, a user provides the SEGA with that user's user location. By entering a start and end time into the “my available time window” fields, the user provides that user's user time window.

The FIG. 5 webpage also invites the user 145 to optionally enter a “proposed user interest” and “proposed venue.” If the user chooses to provide a “proposed user interest,” that user interest is given priority with that particular user when deciding what type of a social event will be generated for that user in the next several method steps. In other words, by entering a proposed user interest, the user temporarily overrides the set of user interests associated with that user during registration (step 210 in FIG. 2). The “proposed venue” field allows the user to suggest a venue for a social event if that user so desires (the effect of which is discussed below).

After the user location and user time window data has been received in step 410, the method then progresses to step 420, wherein the SEGA 100 uses this information to determine one or more “common interest groups.” A common interest group is defined herein as a subgroup of the users 145 having: 1) user locations that collectively exceed a predetermined geographic density; 2) overlapping user time windows; and 3) a common user interest. As just one example, a common interest group might comprise a subgroup of users with user locations clustered around Central Park in New York City, user time windows that commonly indicate availability from 6 pm to 9 pm on a given Saturday, and a common user interest in “discussing books.”

Because there are three simultaneous requirements for the determination of a common interest group, one manner for finding a common interest group is to simply address each requirement in succession. For example, the SEGA 100 might first determine a first subgroup of users 145 with overlapping user time windows. The SEGA might then take this first subgroup and determine a second subgroup of the first subgroup having user locations meeting the required geographic density. Finally, the SEGA might examine the second subgroup of users for a third subgroup with a common user interest. In such a logical succession, the third subgroup would be the common interest group. With respect to the geographic requirement, one manner in which SEGA can determine a subgroup of users having user locations meeting the predetermined geographic density is by having the data processor 105 apply a “k-means algorithm” to the user location data. Such an algorithm is a common form of pattern recognition and, as a result, its implementation on a computer having a data processor in signal communication with a memory like the illustrative SEGA would be familiar to one skilled in the art. Moreover, such an algorithm is described in Richard O. Duda, Peter E. Hart, David G. Stork, “Pattern Classification,” Second Edition, Wiley-Interscience, 2000, which is hereby incorporated by reference herein. The predetermined geographic density may, for example, be three users per square mile, although this particular density figure is merely illustrative and any other user density figure would still fall within the scope of the invention. Where street addresses need to be converted to latitude/longitude coordinates, conventional geocoding algorithms may be utilized.

Optionally, the SEGA 100 may be programmed to drop those common interest groups determined in step 420 that do not meet a predetermined number of users 145. Such a predetermined number of users might, for example, be ten users, although this number is, again, only illustrative.

Subsequently, in step 430, the SEGA 100 determines a proposed venue and meeting time for each common interest group determined in step 420. The SEGA preferably does so by querying the search engine 155 for an appropriate venue that is proximate to the user locations of the users within the common interest group (e.g., within 5-10 miles). The type of venue appropriate to each common user interest will be preprogrammed into the SEGA and stored in, for example, the application memory 125. An appropriate venue for a common interest group associated with “discussing books” might be a coffee shop or restaurant. In contrast, an appropriate venue for a common interest group associated with “playing softball” might be a city park. In yet another contrast, in the virtual world, an appropriate venue for a common interest group associated with “leveling up” might be a field where players can use their in-game skills, and so forth. Searching for “coffee shop” in Poughkeepsie, New York on Google Maps, for example, presently provides the name, address, phone number, and, in many cases, consumer reviews for 17 coffee-shop-like venues within that particular city. Where, as in this case, the search engine produces several venue results, the data processor 105 will determine the best option based on one or more criteria, including, but not limited to, proposed venues optionally entered by users during “check-in,” proximity to the user locations of the users in the common interest group, and available user ratings. Optionally, the venues may also be allowed to pay a fee to the operators of the SEGA 100 in order to increase their venue's chances of being chosen by the SEGA for a social event. With respect to the meeting time, the SEGA will preferably choose a meeting time that falls within the time period defined by the overlap of the user time windows of the users within the particular common interest group for which the social event is being generated. For the Central Park common interest group described above, for example, the SEGA might schedule a meeting time of 6 pm on Saturday.

Additionally and optionally, as part of determining a proposed venue and meeting time in step 430, the SEGA 100 may also inquire in advance as to whether an operator of a venue is willing to host a social event. For example, when an email address for the venue is available from the search engine 155, the SEGA may send the venue an email message with the particulars of the proposed social event (e.g., date and time) and seek confirmation that the venue is, in fact, available. Alternatively, where only a telephone number is available, the SEGA may call the venue and play an electronically generated voice message seeking the same information, or, as another option, may instruct a human operator to call the venue. Where a venue is determined to be unavailable, the SEGA can simply replace that venue with another choice before moving on to step 440.

In step 440, the SEGA 100 then polls the users 145 within each common interest group determined in step 430 as to whether they would attend the proposed social events determined in step 440. In this illustrative embodiment, the SEGA 100 does so by having the web server 110 send an email message, SMS message, MMS, or IRC message to each relevant user. The exact format of the message may be determined by each user's profile (see FIG. 3). An example of such a message is shown in FIG. 6. The message recites the common user interest, the location of the proposed venue, and the proposed meeting time. In addition, the message allows each recipient to transmit a message back to the SEGA that indicates whether that user will in fact attend the proposed social event.

Next, in step 450, the SEGA 100 determines whether there is sufficient attendance to finalize each social event proposed in step 430. For any given proposed social event, this decision again depends on whether a predetermined number of users indicate that they will attend that event. The predetermined number may, as just an example, be five members indicating their attendance. If attendance exceeds this predetermined number, the SEGA proceeds to step 460. If attendance falls below this number, the attendance is determined to be insufficient and the SEGA optionally may adjust in various ways either by broadening the time window or by broadening the geographical spread of the cluster and go back to step 420, or it may drop that event all together if it has looped through this broadening step a predetermined number of times and does not proceed any further in its implementation.

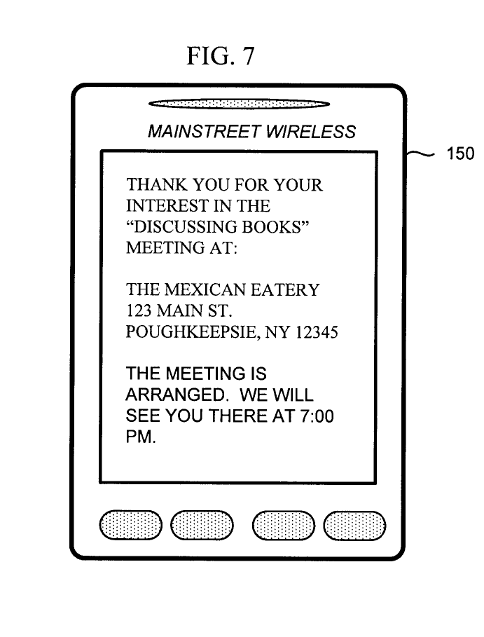

Lastly, for each social event determined to have sufficient attendance in step 450, the SEGA 100 finalizes the social event in steps 460 and 470. To avoid having a venue be surprised by the appearance of a lot of users 145, the SEGA 100 in step 460 informs the operator of the venue in advance about the social event (e.g., by email or by phone). Then, in step 470, the SEGA 100 informs those users 145 of the associated common interest group who indicated their attendance in step 440 that the social event will, in fact, take place. As before, the information is transmitted by the web server 110 in an email message or by an SMS, MMS message, or other means such as IRC message. An example of such a message is shown in FIG. 7.

Thus, embodiments in accordance with aspects of the invention advantageously address several of the disadvantages and weaknesses found in other social planning systems. Firstly, embodiments of the invention generate social events based on happenstance geographic clustering of users rather than based on memberships in regionalized groups. A user is not required to pre-join one or more groups in order to be invited to social events. In addition, a user who is travelling is availed of the possibility of social events no matter where that user happens to be presently located. Secondly, embodiments of the invention also automatically propose, plan, and communicate the details of social events without requiring that the members of a group perform those tasks. As a result, social events can take place more often because less dependence is placed on the level of motivation and engagement of the various members.

It should again be emphasized that the above-described embodiments of the invention are intended to be illustrative only. Other embodiments can use other physical elements or method steps to implement the described functionality. These numerous alternative embodiments within the scope of the appended claims will be apparent to one skilled in the art. For example, as indicated above when referring to “virtual worlds,” apparatus and methods in accordance with aspects of the invention may reference locations of virtual characters on virtual landscapes rather than using locations of users 145 on the Earth. Such virtual landscapes may be provided by massively multi-player online-role-playing games such as World of Warcraft® available from Blizzard Entertainment Inc. (Irvine, Calif., USA) or virtual social spaces such as Second Life® provided by Linden Research, Inc. (San Francisco, Calif., USA). After determining that a common interest group of such virtual characters exists on a virtual landscape, the SEGA 100 may then propose social events for the virtual characters and their human controllers. For example, the SEGA might propose that the virtual characters meet at a particular location on the virtual landscape at a particular time. Alternatively, the SEGA might propose that the human controllers meet in a “chat room” or other such social venue on the Internet.

Finally, it should also be emphasized that all the features disclosed herein may be replaced by alternative features serving the same, equivalent, or similar purpose, unless expressly stated otherwise. Thus, unless expressly stated otherwise, each feature disclosed is one example only of a generic series of equivalent or similar features.

What is claimed is:

1. A method for generating a social event, the method to be performed by a computer having a data processor in signal communication with a memory, the method comprising the steps of:
associating each user of a plurality of users with a respective user time window, a respective user location, and at least one respective user interest;
determining a common interest group, the common interest group comprising a subgroup of the plurality of users having user locations that collectively exceed a predetermined geographic density, overlapping user time windows, and a common user interest;
determining a venue and a meeting time for the social event; and
transmitting the venue and meeting time to at least a portion of the users within the common interest group.

2. The method of claim 1, wherein the step of associating each user of the plurality of users with a respective user time window, a respective user location, and at least one respective user interest comprises receiving information from a user's communication device.

3. The method of claim 1, wherein a user location is a position on the Earth.

4. The method of claim 1, wherein a user location is a position on a virtual landscape.

5. The method of claim 1, wherein the step of associating each user of a plurality of users with a respective user time window, a respective user location, and at least one respective user interest comprises presenting a user with a website on which the user may indicate a user interest.

6. The method of claim 1, wherein the step of associating each user of the plurality of users with a respective user time window, a respective user location, and at least one respective user interest comprises searching an external or internal source for data indicative of a user interest.

7. The method of claim 1, wherein the step of determining the common interest group comprises utilizing a k-means algorithm.

8. The method of claim 1, wherein the common interest group exceeds a predetermined number of users.

9. The method of claim 1, wherein the step of determining the venue and the meeting time for the social event comprises accessing a search engine.

10. The method of claim 1, wherein the venue is substantially proximate to the user locations associated with the users within the common interest group.

11. The method of claim 1, wherein the meeting time is within a time period defined by the overlap of the user time windows of the users within the common interest group.

12. The method of claim 1, wherein the step of transmitting the venue and meeting time to the users within the common interest group comprises sending data to a user's communication device.

13. The method of claim 1, further comprising the step of polling a user in the common interest group for whether that user plans to attend the social event.

14. The method of claim 1, further comprising the step of communicating the venue and meeting time of the social event to an operator of the venue using an electronic mail message or an electronically-generated phone message.

15. An apparatus for generating a social event, the apparatus comprising:
a memory portion, the memory portion operative to associate each user of a plurality of users with a respective user time window, a respective user location, and at least one respective user interest;
a data processing portion, the data processing portion operative to: determine a common interest group, the common interest group comprising a subgroup of the plurality of users having user locations that collectively exceed a predetermined geographic density, overlapping user time windows, and a common user interest; and determine a venue and a meeting time for the social event; and
a communication portion, the communication portion operative to transmit the venue and meeting time to at least a portion of the users within the common interest group.

16. The apparatus of claim 15, wherein the communication portion further comprises a web server operative to send and receive at least one of Hypertext Transfer Protocol data, electronic mail messages, messages in accordance with the Short Message Service format, messages in accordance with the Multimedia Message Service format, and messages in accordance with the Internet Relay Chat format.

17. The apparatus of claim 15, wherein the communication portion is operative to communicate with a user via a user's communication device.

18. Computer instructions for generating a social event embodied on one or more computer-usable media, the computer instructions, when executed by a computer having a data processor in signal communication with a memory, operative to cause the computer to perform the steps of:
associating each user of a plurality of users with a respective user time window, a respective user location, and at least one respective user interest;
determining a common interest group, the common interest group comprising a subgroup of the plurality of users having user locations that collectively exceed a predetermined geographic density, overlapping user time windows, and a common user interest;
determining a venue and a meeting time for the social event; and
transmitting the venue and meeting time to at least a portion of the users within the common interest group.
